(19) United States
(12) Patent Application Publication
(10) Pub. No.: US 2022/0258285 A1
(43) Pub. Date: Aug. 18, 2022

(54) LASER CUTTING METHOD AND ASSOCIATED LASER CUTTING DEVICE

(71) Applicant: Photon Energy GmbH, Ottensoos (DE)

(72) Inventors: Hans Amler, Lauf a. d. Pegnitz (DE); Sergey Polushkin, Ottensoos (DE)

(21) Appl. No.: 17/737,213

(22) Filed: May 5, 2022

Related U.S. Application Data
(63) Continuation of application No. PCT/EP2020/080823, filed on Nov. 3, 2020.

(30) Foreign Application Priority Data
Nov. 5, 2019 (DE) 10 2019 217 021.8

(51) Int. Cl. B23K 26/53; C03B 33/02; B23K 26/40

(52) U.S. Cl. CPC B23K 26/53; B23K 2103/54; B23K 26/40; C03B 33/0222

(57) ABSTRACT

A laser cutting method cuts a planar material using an associated laser cutting device. In a first step the material to be cut is weakened along a provided cutting line by irradiation by a pulsed first laser beam. In a second step, the material to be cut is locally heated by irradiation by a second laser beam in the region of the cutting line in order to produce material stress. In the second step, the material to be cut is heated only in one place or in a plurality of spaced apart places on the cutting line.

### CROSS-REFERENCE TO RELATED APPLICATION

This application is a continuation, under 35 U.S.C. § 120, of copending International Patent Application PCT/EP2020/080823, filed Nov. 3, 2020, which designated the United States; this application also claims the priority, under 35 U.S.C. § 119, of German Patent Application DE 10 2019 217 021.8, filed Nov. 5, 2019; the prior applications are herewith incorporated by reference in their entirety.

### FIELD AND BACKGROUND OF THE INVENTION

The invention relates to a laser cutting method for cutting planar material and also to an associated laser cutting device.

In conventional laser cutting methods, on the material to be cut often a linear predetermined breaking location is first produced by the material to be cut being weakened, in particular perforated, by a short pulse laser beam in a series of burning points along a provided cutting line. In the case of brittle materials such as tempered glass, for example, this weakening or perforation can be sufficient in order then to be able to separate the material along the cutting line. In the case of other materials such as untempered glass or silicon, for example, an additional thermal treatment is required, which produces, in the material to be cut, material stresses in a targeted manner in the region of the cutting line, which facilitate the separation of the material. For this thermal treatment, the cutting line is usually traversed with a continuous and only weakly focused or even unfocused laser beam.

What is disadvantageous about such methods is that the thermal treatment permits only a comparatively low working speed, especially since the possible radiation intensity in this step is limited in order to preclude damage to the material. Consequently, in the second step, a comparatively long irradiation duration is required in order to ensure a sufficient energy deposition. Customary laser cutting methods are thus handicapped as it were by the thermal treatment and have only a restricted efficiency as a result.

### SUMMARY OF THE INVENTION

The invention is based on the object of specifying a particularly efficient laser cutting method for cutting planar material and also an associated laser cutting device.

With regard to the laser cutting method, the object is achieved according to the invention by means of the features of the independent method claim. With regard to the laser cutting device, the object is achieved according to the invention by means of the features of the independent laser cutting device claim. Configurations and further developments of the invention that are advantageous and in part inventive in themselves are set out in the dependent claims and the following description.

According to the method, in a first step (also referred to as “burning step”), the material to be cut is weakened, in particular perforated, by irradiation with a pulsed first laser beam along a provided cutting line. In a second step (also referred to as “thermal treatment”), the material to be cut is then locally heated by irradiation with a second laser beam in the region of the cutting line in order to produce a material stress. According to the invention, in this case, in the second step, the material to be cut is not heated continuously along the entire cutting line. Rather, in the second step, the material to be cut is heated only in pointwise fashion, specifically at one (single) point or at a plurality of mutually spaced apart points, on the cutting line. In one preferred embodiment of the invention, in this case, in the second step, the material to be cut is heated at exactly two points, wherein these two points are arranged in particular in the vicinity of the two ends of the cutting line.

The invention is based on the insight that pointwise heating of the material to be cut during the thermal treatment suffices for producing the material stress sufficient for cleanly separating the material. Since the material does not have to be heated along the entire cutting line, the working speed of the thermal treatment is significantly increased. In particular, this enables the working speeds of the two method steps to be approximately matched to one another, thereby enabling the method to be carried out particularly efficiently.

In an expedient embodiment, the method contains a third step following the thermal treatment. The third step is a mechanical separation step in which the material to be cut is separated by mechanical loading, in particular by bending, shearing and/or pulling apart of the material to be cut, at the cutting line. The third step is omitted in the case of materials which spontaneously crack or break under the influence of the material stresses produced during the thermal treatment.

The first laser beam used in the burning step is preferably focused by an axicon to form a Bessel-like beam (referred to hereinafter as “Bessel beam” for simplification). In this case, the material to be cut is arranged in the focus region of this Bessel beam. In accordance with the customary definition, the term axicon denotes an optical unit in the form of a conically ground lens that images the light from a point source onto a line along an optical axis of the axicon.

The axicon is preferably selected in such a way that the focus region of the Bessel beam produced by it has a length having at least the thickness of the material to be cut. As a result, during the burning step, enough energy is simultaneously deposited over the entire material thickness in order to weaken the material at the provided burning points over the entire thickness of the material. In an expedient dimensioning, the focus region of the Bessel beam produced by the axicon has for example a length (measured in the beam direction) of 2 millimeters and a width (measured transversely with respect to the beam direction) of 2 to 5 micrometers.

The second laser beam used for the thermal treatment is preferably emitted in merely weakly focused or even unfocused fashion onto the material to be cut.

The light wavelength of the first laser beam is preferably chosen in such a way that the material to be cut is transparent to the light of the first laser beam. In this case, the energy deposition that leads to the weakening, in particular perforation, of the material to be cut in the burning step takes place as a result of nonlinear light absorption of the first laser beam. In this case, the transparency of the material to be cut to the first laser beam has the effect that the energy deposition takes place uniformly over the entire thickness of the material to be cut.

By contrast, the light wavelength of the second laser beam is preferably chosen in such a way that the material to be cut is nontransparent or semitransparent to the light of the second laser beam. This has the effect that as a result of linear absorption of the light energy of the second laser beam, the material to be cut is effectively heated, but not damaged. Semitransparency of the material to be cut to the light of the second laser beam is preferred in order to ensure a high penetration depth of the second laser beam into the material to be cut and thus as uniform heating of the latter as possible over its material thickness.

In an expedient embodiment, the first laser beam is emitted onto the material to be cut in pulses that have a pulse length of between 300 femtoseconds and 30 picoseconds.

In one preferred application, the method described generally above is used for cutting a plate composed of glass, in particular composed of non-tempered glass. In this case, the light wavelength of the first laser beam is preferably fixed to a value of between 0.5 micrometer and 2 micrometers, in particular to approximately 1 micrometer. In one expedient embodiment of the method, in this case, a mode-locked MOPA (Master Oscillator Power Amplifier) ultrashort pulse laser is used for generating the first laser beam. By contrast, the light wavelength of the second laser beam is preferably fixed to a value of between 4 micrometers and 11.5 micrometers, in particular to 5 micrometers or 10 micrometers. In one expedient embodiment of the method, a continuous (i.e. unpulsed) CO₂ laser is used here for generating the second laser beam.

In a further preferred application, the method according to the invention is used for cutting a plate composed of silicon, in particular a wafer. In this case, the light wavelength of the first laser beam is preferably fixed to a value of between 1.5 micrometers and 4 micrometers, in particular to 2 micrometers. In one expedient embodiment of the method, in this case, a mode-locked MOPA ultrashort pulse laser is likewise used for generating the first laser beam. By contrast, the light wavelength of the second laser beam is preferably fixed to a value of between 1 micrometer and 11.5 micrometers, in particular to 1 micrometer or to 5 micrometers. In one expedient embodiment of the method, a continuous (i.e. unpulsed) neodymium-YAG or CO₂ laser is used here for generating the second laser beam.

The laser cutting device according to the invention is configured generally for carrying out the above-described method according to the invention, in particular in one of the embodiment variants described above. In this case, the laser cutting device includes in particular:

a workpiece receptacle for mounting for a plate composed of the material to be cut, a first laser for generating the first laser beam,

a second laser for generating the second laser beam,

a feed mechanism for moving the first laser beam and the second laser beam and the second laser beam relative to the workpiece receptacle, and

a controller for the feed mechanism and the two lasers for carrying out the method according to the invention.

The workpiece receptacle is preferably embodied as a support, onto which the plate composed of the material to be cut is placed. In an expedient embodiment, the support is formed for example by a glass plate with a non-absorbing diffusing layer, e.g. composed of polytetrafluoroethylene, disposed in front.

The feed mechanism is preferably embodied as an (e.g. linear-motor-operated or spindle-operated) X-Y table. In this case, the feed mechanism preferably moves the workpiece receptacle (together with, secured thereto, if appropriate, the plate composed of the material to be cut) relative to the lasers arranged in stationary fashion.

In an alternative embodiment of the laser cutting device, the feed mechanism moves (jointly or independently of one another) the first laser and the second laser relative to the workpiece receptacle arranged in stationary fashion. In a further embodiment of the laser cutting device, instead of the entire lasers, the feed mechanism moves (once again jointly or independently of one another) only a respective beam exit head of the first and second lasers, while further components of the respective laser, in particular the laser resonator and an amplifier optionally present, are arranged in stationary fashion. In this case, the beam exit head moved by the feed mechanism and the components arranged in stationary fashion of the respective laser are coupled to one another for the purpose of guiding the laser beam via a flexible optical fiber, in particular a hollow fiber in the case of the first laser.

Furthermore, the invention also encompasses mixed forms of the embodiment variants described above, in which (independently of one another) both the workpiece receptacle and at least one of the two lasers or beam exit heads are moved by the feed mechanism and/or in which one of the two lasers is moved completely by the feed mechanism, while only a beam exit head of the other laser is moved.

The first laser is preferably formed by a mode-locked MOPA ultrashort pulse laser. In this case, an axicon is disposed downstream of the first laser in order to form a thin and elongated focus region of the first laser beam. The second laser is preferably embodied as a continuous (i.e. unpulsed) neodymium-YAG or CO₂ laser.

The controller is preferably formed by a control computer (e.g. a personal computer or microcontroller), in which a control program for controlling the feed mechanism and the two lasers is implemented. According to the control program, the lasers or their exit heads and/or the workpiece receptacle are/is moved for the purpose of moving the laser beams along a predefined cutting line. In this case, according to the control program, the first laser is controlled in pulsed fashion in such a way that, in a first step, the first laser weakens, in particular perforates, the material mounted in the workpiece receptacle in a series of burning points along the cutting line. According to the control program, the second laser is controlled in such a way that, in a second step, the second laser heats the material to be cut in order to produce a material stress in pointwise fashion at one point or at a plurality of mutually spaced apart points along the cutting line.

The two steps are preferably carried out successively (i.e. temporally sequentially). Particularly if the first laser beam and the second laser beam are movable independently of one another relative to the workpiece receptacle, the two steps can however also be carried out in a temporally overlapping manner within the scope of the invention. In this case, however, in the second step, the material to be cut is heated only in regions of the cutting line in which the material to be cut was previously weakened, in particular perforated, by the first laser beam.

Preferably, the laser cutting device additionally contains a mechanical separation device in order, in a third step, to separate the material to be cut mechanically, in particular by bending, shearing and/or pulling apart of the material to be cut, along the cutting line pretreated by the burning step and the thermal treatment. Within the scope of the invention, the separation device can be formed by the workpiece receptacle itself, which in this case is formed for example from two parts that are tiltable or displaceable in relation to one another. Alternatively, the optional separation device is formed by an apparatus that is detached, optionally also spatially remote, from the workpiece receptacle.

The term “approximately” as part of value indications, unless indicated otherwise, should be understood to mean that it includes a deviation from the indicated value by up to 10 percent (i.e. ±10%), preferably by up to 5 percent (i.e. ±5%).

Other features which are considered as characteristic for the invention are set forth in the appended claims.

Although the invention is illustrated and described herein as embodied in a laser cutting method and associated laser cutting device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a perspective view showing a laser cutting device for cutting a planar material, here a glass plate, containing a workpiece receptacle for mounting the material to be cut, having a first laser for generating the first laser beam, having a second laser for generating the second laser beam, having a feed mechanism for moving the workpiece receptacle relative to the first and second laser beams, and also having a controller for the feed mechanism and the two lasers;

FIG. 2 is a schematic illustration of a beam path of the first laser beam and also an axicon positioned in the beam path;

FIG. 3 is a plan view showing the glass plate after a first step of a method carried out by means of the laser cutting device, in which the glass plate is weakened in a series of burning points along a cutting line by means of the first laser beam;

FIG. 4 is a plan view showing in accordance with FIG. 3, the glass plate after a second step of the method, in which the glass plate is locally heated by means of the second laser beam at a point on the cutting line in order to produce a material stress;

FIG. 5 is a plan view showing in accordance with FIG. 3, the glass plate after a third step of the method, in which the glass plate is separated by mechanical loading, here bending, along the cutting line;

FIG. 6 is an illustration showing in accordance with FIG. 3, as a further example of a material to be cut, a silicon wafer after the first step of the method, in which the silicon wafer is weakened in a series of burning points along the cutting line by means of the first laser beam;

FIG. 7 is an illustration showing in accordance with FIG. 3, the silicon wafer after the second step of the method, in which the silicon wafer is locally heated by means of the second laser beam at two opposite points on the cutting line in order to produce a material stress; and

FIG. 8 is an illustration showing in accordance with FIG. 3, the silicon wafer after the third step of the method, in which the silicon wafer is separated by mechanical loading, here pulling apart, along the cutting line.

### DETAILED DESCRIPTION OF THE INVENTION

Mutually corresponding parts and structures are always provided with identical reference signs in all the figures.

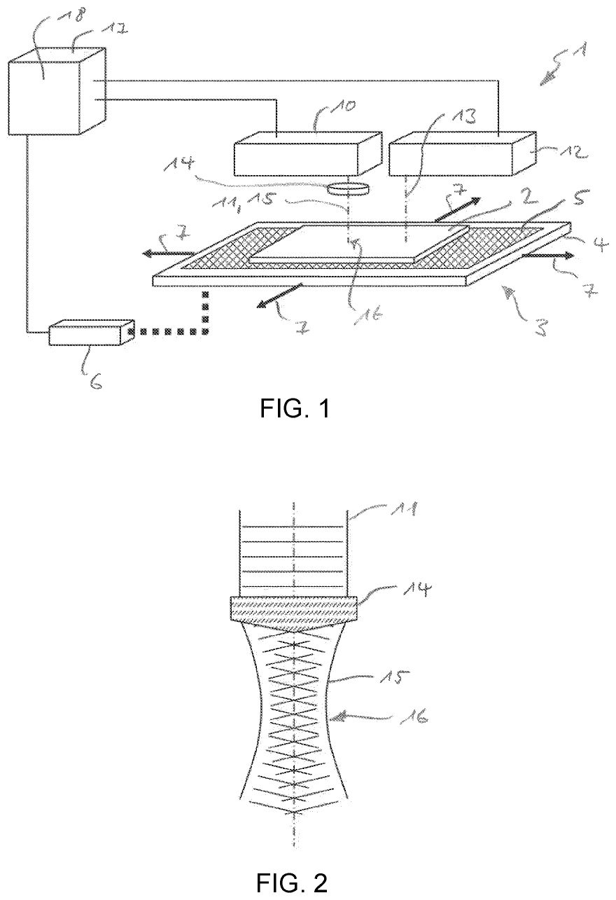

Referring now to the figures of the drawings in detail and first, particularly to FIG. 1 thereof, there is shown, in a roughly schematically simplified perspective illustration, a (laser cutting) device 1 for cutting a planar material, which is a glass plate 2 composed of untempered glass in the example shown here. The glass plate 2 has a thickness of 1 millimeter, for example.

The device 1 contains a workpiece receptacle 3 for mounting the glass plate 2. In this case, the workpiece receptacle 3 is formed by a carrier plate 4 composed of glass, on which a diffusing layer 5 composed of polytetrafluoroethylene is applied on the workpiece side (i.e. on the side on which the glass plate 2 to be cut is placed as intended during operation of the device 1).

The carrier plate 4 has a thickness of 5 centimeters, for example, and the diffusing layer 5 has a thickness of 0.2 millimeter, for example.

The workpiece receptacle 3 is embodied as an X-Y table, in which, by means of a feed mechanism 6 (merely indicated in FIG. 1), the carrier plate 4 is displaceable in directions identified by arrows 7 within a plane parallel to the area of the carrier plate 4. The feed mechanism 6 contains for example two linear motors coupled to the carrier plate 4 in terms of drive technology.

The device 1 furthermore contains first laser 10 for generating a first laser beam 11 and a second laser 12 for generating a second laser beam 13. The two lasers 10 and 12 are mounted above the workpiece receptacle 3 in such a way that the laser beams 11 and 13 respectively emitted by them are aligned in each case perpendicular to the carrier plate 4 on the workpiece-side area thereof. The lasers 10 and 12 are mounted in stationary fashion, such that in the event of an adjustment of the carrier plate 4 by the feed mechanism 6, the glass plate 2 mounted on the carrier plate 4 is moved relative to the laser beams 11 and 13.

The first laser 10 is a mode-locked MOPA ultrashort pulse laser, which generates the first laser beam 11 in the form of laser pulses in the example in accordance with FIG. 1. In this case, the first laser beam 11 has a light wavelength of approximately 1 micrometer, specifically 1064 nanometers, for example. It is thus in the near infrared range of the electromagnetic spectrum, such that the glass plate 2 to be cut is transparent to the first laser beam 11.

An axicon 14 as optical unit is disposed in front of the first laser 10 and focuses the first laser beam 11 to form a Bessel beam 15 with a thin and elongated focus region 16. In an exemplary dimensioning, an axicon 14 forms the focus region 16 of the first laser beam 11 with a width (measured transversely with respect to the beam direction) of 2 to 5 micrometers and a length (measured in the beam direction) of approximately 2 millimeters. The axicon 14, the Bessel beam 15 produced by it and the focus region 16 of the Bessel beam are illustrated in a roughly schematically simplified manner in FIG. 2. In the context of the device 1, the axicon 14 is aligned in relation to the workpiece receptacle 3 in such a way that the focus region 16 of the Bessel beam 15 passes through the glass plate 2 mounted on the carrier plate 4 over the entire thickness of the glass plate.

In the embodiment in accordance with FIG. 1, the second laser 12 is a CO₂ laser, which generates the second laser beam 13 as a continuous (i.e. unpulsed) laser beam having a light waves of approximately 10 micrometers, specifically for example 10.6 micrometers, and a power/intensity of e.g. 100 watts. The light of the second laser beam 13 is thus in the mid-infrared range of the electromagnetic spectrum, such that the glass plate 2 to be cut is semitransparent or even nontransparent to the second laser beam 13, depending on the type of glass. The second laser beam 13 is emitted in unfocused fashion onto the carrier plate 4 and the glass plate 2 mounted thereon.

Finally, the device 1 contains a control computer 17 as controller. A control program 18 is implemented in the control computer 17, according to which control program the control computer 17 controls the feed mechanism 6 and the two lasers 10 and 12 during operation of the device 1.

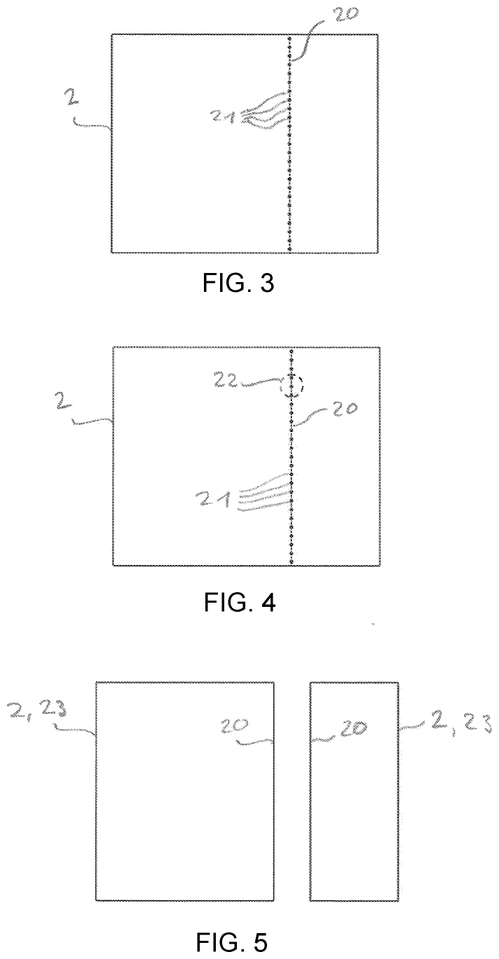

A laser cutting method is carried out as intended by means of the device 1, the laser cutting method having three steps in its application to the cutting of untempered glass. The state of the glass plate 2 after the first and second and third steps is illustrated here in FIGS. 3 to 5, respectively.

In a first step of this method, the first laser beam 11 is guided along a provided cutting line 20 (FIG. 3) over the glass plate 2 to be cut by the carrier plate—under the control of the control program 18 executed in the control computer 17 and in a manner driven by the feed mechanism 6—being moved relative to the first laser 10. In this case, the highly focused, pulsed laser beam 11 produces a series of burning points 21 (FIG. 3) in the glass plate 2 along the cutting line 20, at which points the material of the glass plate 2 is weakened or destroyed by nonlinear absorption of the pulse energy. Owing to the transparency of the glass plate 2 to the light of the first laser beam 11 and the long axial extent of the focus region 16, each burning point 21 extends over the entire thickness of the glass plate 2 with a width of 2 to 5 micrometers. The burning points 21 are produced on the cutting line 20 for example with a spacing of 1 to 10 micrometers, in particular 4 to 5 micrometers. The laser beam 11 emerging from the glass plate 2 is diffused in the diffusion layer 5 in a manner free of absorption, such that the energy density is decreased in the further course of the beam path of the laser beam. As a result, the first laser beam 11 is transmitted through the carrier plate 4 without damaging the latter.

In the subsequent second step of the method, the glass plate 2 to be cut is moved together with the workpiece receptacle 3 in such a way that the second laser beam 13 impinges at a predefined point 22 (FIG. 4) on the cutting line 20. The material of the glass plate 2 is then locally heated at the point 22 by the glass plate 2 being irradiated with the second laser beam 13 for a duration of 5 to 2000 milliseconds, for example. A material stress is produced in the glass plate 2 as a result of this thermal treatment, the material stress supporting the subsequent separation of the glass plate 2 at the cutting line 20.

For this purpose, the third step involves introducing mechanical loading into the glass plate 2, such that the latter breaks at the cutting line 20 pretreated by the preceding steps. As a result of this mechanical loading, after the third step, in accordance with FIG. 5, the glass plate 2 is present in two pieces 23 separated at the cutting line 20. In the exemplary embodiment illustrated here, the mechanical loading is effected by bending of the glass plate 2 by means of a separation device, not explicitly illustrated, which is preferably embodied as an integral mechanism that is automatically actuated by the control computer 17. In this case, the separation device is a lifting mechanism, for example, which locally raises the glass plate 2 and in this way causes bending of the glass plate 2 under the action of its own weight. Alternatively, a separation device detached from the device 1 can also be used for bending the glass plate 2. As yet another alternative, the glass plate 2 can also be manually bent or loaded in some other way.

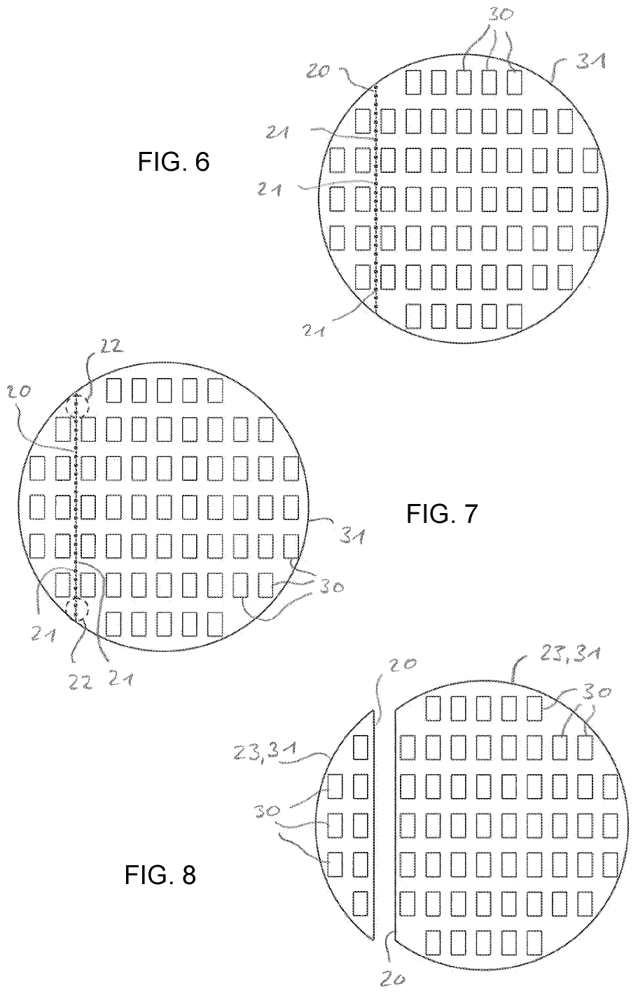

In a further application illustrated with reference to FIGS. 6 to 8, the laser cutting method is used for singulating chips 30 (for example integrated electronic circuits) from a wafer 31 composed of silicon. Analogously to the sequence in FIGS. 3 to 5, FIGS. 6 to 9 show the wafer 31 after the first and second and third steps, respectively, of the method. The method steps are repeated taking different cutting edges 20 as a basis until all chips 30 are present in singulated form.

The variant of the laser cutting method described with reference to FIGS. 6 to 8 is carried out by an embodiment of the device 1 which—apart from the differences described below—corresponds to the device 1 in accordance with FIG. 1. In contrast to the latter embodiment, however, for the purpose of cutting the wafer 31 the first laser 10 and the second laser 12 are configured in such a way that the first laser beam 11 is generated with a light wavelength of 2 micrometers, and the second laser beam 13 is generated with a light wavelength of 1 micrometer. This choice of the light wavelengths ensures that the wafer 31 is transparent to the light of the first laser beam 11 and is semitransparent or nontransparent to the light of the second laser beam 13. Instead of a CO₂ laser, here it is also possible to use a neodymium-YAG laser as second laser 12.

A further difference with respect to the method variant in accordance with FIGS. 3 to 5 is that in the second step, in accordance with FIG. 7, the wafer 31 is heated at two points 22 arranged at opposite ends of the cutting line 20.

Finally, the separation of the wafer 31 in accordance with FIG. 8 is effected by the pieces 23 of the wafer 31 that are delimited by the cutting line 20 being pulled apart. For this purpose, the wafer 31 is preferably adhesively bonded areally on a flexible carrier film, not illustrated, which is stretched in order to separate the pieces 23.

As an alternative to the method sequence illustrated in FIGS. 6 to 8, first all cutting lines 20 required for singulating the chips 30 are pretreated by the first and second steps being repeatedly carried out in succession, without initially dividing the wafer 31. Afterward, by means of the third step being carried out once, namely by means of the carrier film being stretched once, all chips 31 of the wafer 30 are separated from one another simultaneously.

The invention becomes particularly clear from the exemplary embodiments above. Nevertheless, it is not restricted to these exemplary embodiments, however. Rather, numerous further embodiments of the invention can be derived from the claims and the description above. In particular, individual features of the exemplary embodiments described above can also be combined in other ways, without departing from the invention.

The following is a summary list of reference numerals and the corresponding structure used in the above description of the invention:
1 (Laser cutting) device
2 Glass plate
3 Workpiece receptacle
4 Carrier plate
5 Diffusing layer
6 Feed mechanism
7 Arrow
10 (First) laser
11 (First) laser beam
12 (Second) laser
13 (Second) laser beam
14 Axicon
15 Bessel beam
16 Focus region
17 Control computer
18 Control program
20 Cutting line
21 Burning point
22 Point
23 Piece
30 Chip
31 Wafer

1. A laser cutting method for cutting a planar material, which comprises:
performing a first step of weakening the planar material to be cut by irradiation with a pulsed first laser beam along a provided cutting line; and
performing a second step of locally heating the planar material to be cut by irradiation via a second laser beam in a region of the cutting line to produce a material stress, wherein the planar material to be cut is heated only at one point or at a plurality of mutually spaced apart points on the cutting line.

2. The method according to claim 1, wherein, in the second step, the planar material to be cut is heated only at exactly two mutually spaced apart points on the cutting line.

3. The method according to claim 1, which further comprises performing a third step, in which the planar material to be cut is separated by mechanical loading.

4. The method according to claim 1, which further comprises focusing the first laser beam using an axicon to form a Bessel beam, and in a focus region of the Bessel beam the planar material to be cut is disposed.

5. The method according to claim 1, which further comprises emitting the second laser beam in a weakly focused or unfocused fashion onto the planar material to be cut.

6. The method according to claim 1, wherein the planar material to be cut is transparent to the pulsed first laser beam.

7. The method according to claim 1, wherein the planar material to be cut is nontransparent or semitransparent to the second laser beam.

8. The method according to claim 1, which further comprises emitting the pulsed first laser beam in pulses having a pulse length of between 300 femtoseconds and 30 picoseconds onto the planar material to be cut.

9. The method according to claim 1, which further comprises providing a glass plate as the planar material to be cut, wherein the pulsed first laser beam has a wavelength of approximately 1 micrometer, and wherein the second laser beam has a wavelength of approximately 10 micrometers.

10. The method according to claim 1, which further comprises providing a plate composed of silicon as the planar material to be cut, wherein the pulsed first laser beam has a wavelength of approximately 2 micrometers, and wherein the second laser beam has a wavelength of approximately 1 micrometer.

11. The method according to claim 1, which further comprises performing the first step by perforating the planar material.

12. The method according to claim 3, which further comprises performing the mechanical loading by bending, shearing and/or pulling apart the planar material to be cut at the cutting line.

13. The method according to claim 9, which further comprises forming the glass plate from non-tempered glass.

14. A laser cutting device for cutting planar material, the laser cutting device configured for carrying out the method according to claim 1.
